(19) United States
(12) Patent Application Publication
(10) Pub. No.: US 2018/0085278 A1
(43) Pub. Date: Mar. 29, 2018

(54) WALKING TRAINING APPARATUS AND ITS CONTROL METHOD

(71) Applicant: TOYOTA JIDOSHA KABUSHIKI KAISHA, Toyota-shi (JP)

(72) Inventor: Tomoe MAEKITA, Toyota-shi (JP)

(73) Assignee: TOYOTA JIDOSHA KABUSHIKI KAISHA, Toyota-shi (JP)

(21) Appl. No.: 15/682,598

(22) Filed: Aug. 22, 2017

(30) Foreign Application Priority Data
Sep. 28, 2016 (JP) 2016-190292

(51) Int. Cl. A61H 1/02

(52) U.S. Cl. CPC A61H 1/0262; A61H 2001/0207; A61H 2001/0211; A61H 1/0229

(57) ABSTRACT

A walking training apparatus includes a first wire winding mechanism configured to pull a wire connected to a leg upward and forward, and control means. The control means performs at least one of control, in a leg-idling period, so as to make the first wire winding mechanism generate a driving force obtained by adding a second driving force for reducing a loss of the pulling force of the first wire winding mechanism caused by mechanical friction in the first wire winding mechanism to the first driving force, and control, in a leg-standing period, so as to make the first wire winding mechanism generate a driving force obtained by subtracting the second driving force for reducing the loss of the pulling force of the first wire winding mechanism caused by the mechanical friction in the first wire winding mechanism from the first driving force.

### CROSS REFERENCE TO RELATED APPLICATIONS

This application is based upon and claims the benefit of priority from Japanese patent application No. 2016-190292, filed on Sep. 28, 2016, the disclosure of which is incorporated herein in its entirety by reference.

### BACKGROUND

The present disclosure relates to a walking training apparatus by which a trainee does a walking training, and its control method.

There is a known walking training apparatus that includes: a walking assistance apparatus that assists a walking motion performed by a trainee; a first wire winding mechanism for pulling a wire connected to trainee's leg upward and forward by winding the wire connected to the leg, the first wire winding mechanism being configured to wind and store the wire by rotating a motor in a leg-idling period in which the leg is in an leg-idling state in the walking motion of the trainee and to pay out (i.e., pull out) the wire by rotating the motor in a leg-standing period in which the leg is in a leg-standing state in the walking motion of the trainee; and control means for controlling the pulling force of the first wire winding mechanism and thereby reducing the gravitational force of the walking assistance apparatus (see, for example, Japanese Unexamined Patent Application Publication No. 2015-223294).

### SUMMARY

The present inventors have found the following problem. In the above-described walking training apparatus, when the first wire winding mechanism winds or pays out (i.e., pulls out) the wire, mechanical friction occurs in the first wire winding mechanism. Because of this mechanical friction, when the first wire winding mechanism winds the wire, the actual pulling force applied by the first wire winding mechanism becomes smaller than the target pulling force by an amount equivalent to this mechanical friction. On the other hand, when the first wire winding mechanism pays out the wire, the actual pulling force applied by the first wire winding mechanism becomes larger than the target pulling force by the amount equivalent to this mechanical friction. As a result, there is a possibility that the pulling force might not smoothly change at or near the timing at which the leg-idling period and the leg-standing period are switched from one to the other.

The present disclosure has been made in view of the above-described problem and a main object thereof is to provide a walking training apparatus capable of bringing the actual pulling force of the first wire winding mechanism close to the target pulling force thereof in at least one of the leg-idling period and the leg-standing period and thereby enabling the pulling force to be changed smoothly at and near the timing at which the leg-idling period and the leg-standing period are switched from one to the other, and to provide its controlling method.

To achieve the above-described object, an aspect of the present disclosure is a walking training apparatus including: a walking assistance apparatus configured to be attached to a leg of a trainee and assist a walking motion performed by the trainee; a first wire winding mechanism configured to pull a wire connected to the leg directly or through the walking assistance apparatus upward and forward by winding the wire connected to the leg; and control means for controlling a driving force of a motor of the first wire winding mechanism by using a first driving force as a base driving force, the first driving force being determined in advance so as to reduce a gravitational force of the walking assistance apparatus, in which the first wire winding mechanism winds the wire by rotating the motor in a leg-idling period and pays out the wire by rotating the motor in a direction opposite to the direction in the leg-idling period in a leg-standing period, the leg-idling period being a period in which the leg is in an leg-idling state in the walking motion of the trainee, the leg-standing period being a period in which the leg is in a leg-standing state in the walking motion of the trainee, and in which the control means performs at least one of: control, in the leg-idling period, so as to make the motor of the first wire winding mechanism generate a driving force obtained by adding a second driving force to the first driving force, the second driving force being a force for reducing a loss of the pulling force of the first wire winding mechanism caused by mechanical friction in the first wire winding mechanism; and control, in the leg-standing period, so as to make the motor of the first wire winding mechanism generate a driving force obtained by subtracting the second driving force from the first driving force, the second driving force being the force for reducing the loss of the pulling force of the first wire winding mechanism caused by the mechanical friction in the first wire winding mechanism.

In this aspect, the walking training apparatus may further include a second wire winding mechanism configured to pull the wire connected to the leg directly or through the walking assistance apparatus upward and backward by winding the wire connected to the leg, in which the second wire winding mechanism may wind the wire by rotating the motor in the leg-idling period and pay out the wire by rotating the motor in the direction opposite to the direction in the leg-idling period in the leg-standing period, the leg-idling period being the period in which the leg is in the leg-idling state in the walking motion of the trainee, the leg-standing period being the period in which the leg is in the leg-standing state in the walking motion of the trainee, and the control means may control a driving force of a motor of the second wire winding mechanism by using a third driving force as a base driving force, the third driving force being determined in advance so as to reduce the gravitational force of the walking assistance apparatus, and in which the control means may perform at least one of: control, in the leg-idling period, so as to make the motor of the second wire winding mechanism generate a driving force obtained by subtracting a fourth driving force from the third driving force, the fourth driving force being a force for reducing a loss of the pulling force of the second wire winding mechanism caused by mechanical friction in the second wire winding mechanism; and control, in the leg-standing period, so as to make the motor of the second wire winding mechanism generate a driving force obtained by adding the fourth driving force to the third driving force, the fourth driving force being the force for reducing the loss of the pulling force of the second wire winding mechanism caused by the mechanical friction in the second wire winding mechanism.

To achieve the above-described object, an aspect of the present disclosure may be a control method for a walking training apparatus, the walking training apparatus including: a walking assistance apparatus configured to be attached to a leg of a trainee and assist a walking motion performed by the trainee; a first wire winding mechanism configured to pull a wire connected to the leg directly or through the walking assistance apparatus upward and forward by winding the wire connected to the leg; and control means for controlling a driving force of a motor of the first wire winding mechanism by using a first driving force as a base driving force, the first driving force being determined in advance so as to reduce a gravitational force of the walking assistance apparatus, in which the first wire winding mechanism winds the wire by rotating the motor in a leg-idling period and pays out the wire by rotating the motor in a direction opposite to the direction in the leg-idling period in a leg-standing period, the leg-idling period being a period in which the leg is in an leg-idling state in the walking motion of the trainee, the leg-standing period being a period in which the leg is in a leg-standing state in the walking motion of the trainee, and in which the control method includes at least one of: performing control, in the leg-idling period, so as to make the motor of the first wire winding mechanism generate a driving force obtained by adding a second driving force to the first driving force, the second driving force being a force for reducing a loss of the pulling force of the first wire winding mechanism caused by mechanical friction in the first wire winding mechanism; and performing control, in the leg-standing period, so as to make the motor of the first wire winding mechanism generate a driving force obtained by subtracting the second driving force from the first driving force, the second driving force being the force for reducing the loss of the pulling force of the first wire winding mechanism caused by the mechanical friction in the first wire winding mechanism.

According to the present disclosure, it is possible to provide a walking training apparatus capable of bringing the actual pulling force of the first wire winding mechanism close to the target pulling force thereof in at least one of the leg-idling period and the leg-standing period and thereby enabling the pulling force to be changed smoothly at and near the timing at which the leg-idling period and the leg-standing period are switched from one to the other, and to provide its controlling method.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a perspective view showing a schematic configuration of a walking training apparatus according to a first embodiment of the present disclosure;

FIG. 2 is a perspective view showing a schematic configuration of a walking assistance apparatus;

FIG. 3 is a block diagram showing an example of a schematic system configuration of a control device according to the first embodiment of the present disclosure;

FIG. 4 is a flowchart showing a flow of a method for controlling a walking training apparatus according to the first embodiment of the present disclosure;

FIG. 5 shows a schematic configuration of a walking training apparatus according to a second embodiment of the present disclosure; and

FIG. 6 is a flowchart showing a flow of a method for controlling a walking training apparatus according to the second embodiment of the present disclosure.

### DESCRIPTION OF EMBODIMENTS

### First Embodiment

Embodiments according to the present disclosure are explained hereinafter with reference to the drawings.

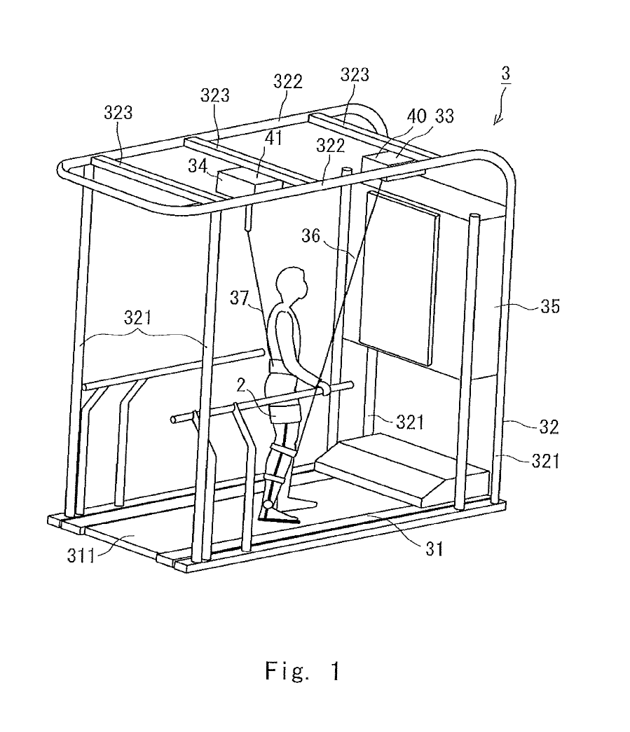

FIG. 1 is a perspective view showing a schematic configuration of a walking training apparatus according to a first embodiment of the present disclosure. A walking training apparatus 1 according to the first embodiment is, for example, an apparatus by which a trainee such as a patient having hemiplegia caused by a stroke does walking training. The walking training apparatus 1 includes a walking assistance apparatus 2 attached to the trainee's leg and a training apparatus 3 by which the trainee does walking training.

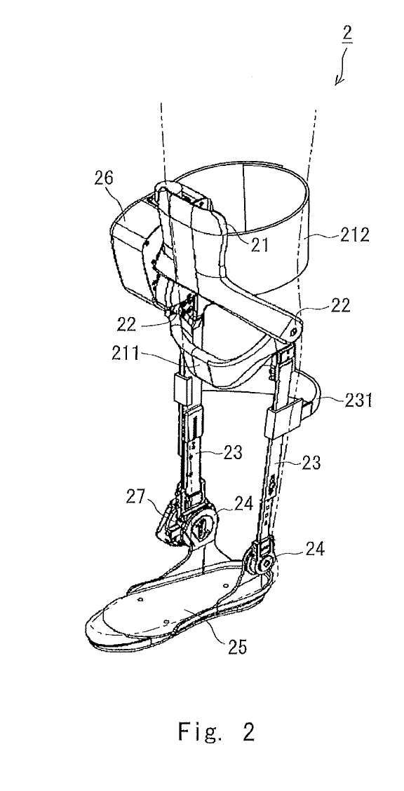

FIG. 2 is a perspective view showing a schematic configuration of the walking assistance apparatus. The walking assistance apparatus 2 is, for example, attached to a diseased leg of a trainee who does a walking training and assists walking of the trainee. The walking assistance apparatus 2 includes an upper thigh frame 21, a lower thigh frame 23 connected to the upper thigh frame 21 through a knee joint part 22, a sole frame 25 connected to the lower thigh frame 23 through an ankle joint part 24, a motor unit 26 that rotationally drives the knee joint part 22, and an adjustment mechanism 27 that adjusts the movable range of the ankle joint part 24. Note that the above-described configuration of the walking assistance apparatus 2 is merely an example and the configuration of the walking assistance apparatus 2 is not limited to such an example. For example, the walking assistance apparatus 2 may include another motor unit that rotationally drives the ankle joint part 24.

The upper thigh frame 21 is attached to the upper thigh of the trainee's leg and the lower thigh frame 23 is attached to the lower thigh of the trainee's leg. The upper thigh frame 21 is, for example, equipped with an upper thigh harness 212 for fixing the upper thigh. The upper thigh frame 21 is equipped with a horizontally-extending and horizontally-long first frame 211 for connecting with a wire 36 of a first wire winding mechanism 33 (which is described later).

Note that the above-described connecting part of the first wire winding mechanism 33 is merely an example and the connection of the first wire winding mechanism 33 is not limited to such an example. For example, the wire 36 of the first wire winding mechanism 33 may be connected to the upper thigh harness 212 and the pulling point of the first wire winding mechanism 33 can be disposed at an arbitrary position in the walking assistance apparatus 2.

The motor unit 26 rotationally drives the knee joint part 22 according to the walking motion of the trainee and thereby assists the walking of the trainee. Note that the above-described configuration of the walking assistance apparatus 2 is merely an example and the configuration of the walking assistance apparatus 2 is not limited to such an example. Any walking assistance apparatus capable of being attached to the trainee's leg and assisting walking of the trainee can be applied.

As shown in FIG. 1, the training apparatus 3 includes a treadmill 31, a frame main body 32, first and third wire winding mechanisms 33 and 34, and a control device 35. The treadmill 31 rotates a ring-shaped belt 311. The trainee gets on the belt 311 and walks on the belt 311 according to the movement of the belt 311. By doing so, the trainee does walking training.

The frame main body 32 includes two pairs of pillar frames 321 vertically disposed on the treadmill 31, a pair of lengthwise frames 322 extending in the lengthwise direction and connected to respective pillar frames 321, and three crosswise frames 323 extending in the crosswise direction and connected to each of the lengthwise frames 322. Note that the configuration of the above-described frame main body 32 is merely an example and is not limited to this example.

In the front crosswise frame 323, the first wire winding mechanism 33 that winds the wire 36 connected to the trainee's leg directly or through the walking assistance apparatus 2 and thereby pulls the wire 36 is provided. One end of the wire 36, which is pulled by the first wire winding mechanism 33, is connected to the walking assistance apparatus 2. The first wire winding mechanism 33 pulls the walking assistance apparatus 2 upward and forward through the wire 36 by winding the wire 36.

The first wire winding mechanism 33 includes, for example, a rotor winding/rewinding mechanism for winding the wire 36 around a rotor and paying out (i.e., pulling out) the wire 36 from the rotor, a motor that drives this winding/rewinding mechanism, and so on. The first wire winding mechanism 33 is configured so as to wind the wire 36 around the rotor and thereby store the wire 36 in a leg-idling period in the walking motion performed by the trainee in which the trainee's leg is in a leg-idling state and pay out (i.e., pull out) the wire 36 from the rotor in a leg-standing period in the walking motion performed by the trainee in which the trainee's leg is in a leg-standing state.

The vertically-upward component of the pulling force applied by the first wire winding mechanism 33 supports the weight of the walking assistance apparatus 2. The horizontally-forward component of the pulling force applied by the first wire winding mechanism 33 assists the start of swinging of the leg. In this way, the walking load of the trainee in the walking training can be reduced.

The third wire winding mechanism 34 is disposed in the rear crosswise frame 323 and pulls a wire 37 upward. One end of the wire 37 is connected to, for example, a belt attached to at and near the trainee's waist. The third wire winding mechanism 34 includes, for example, a mechanism for winding the wire 37 around a rotor and pulling the wire 37 from the rotor, a motor that drives this mechanism, and so on. The third wire winding mechanism 34 pulls the trainee's waist upward through the wire 37. In this way, the load on the trainee caused by the weight of the trainee himself/herself can be reduced. Each of the first and third wire winding mechanism 33 and 34 is connected to the control device 35 through a wiring line or the like.

The control device 35 is a specific example of the control means. The control device 35 controls the pulling forces applied by the first and third wire winding mechanisms 33 and 34, the driving of the treadmill 31, and the walking assistance apparatus 2, respectively.

For example, the control device 35 is formed by hardware mainly using a microcomputer including a CPU (Central Processing Unit) that performs arithmetic processing, control processing, and so on, a memory including a ROM (Read Only Memory) that stores an arithmetic program, a control program and so on to be executed by the CPU, a RAM (Random Access Memory) and so on, and an interface unit (I/F) that externally receives and outputs signals. The CPU, the memory, and the interface unit are connected with each other through a data bus or the like.

It should be noted that when the first wire winding mechanism winds or pays out the wire, mechanical friction occurs in the first wire winding mechanism. Because of this mechanical friction, when the first wire winding mechanism winds the wire, the actual pulling force applied by the first wire winding mechanism through the wire becomes smaller than the target pulling force by an amount equivalent to a loss caused by this mechanical friction. On the other hand, when the first wire winding mechanism pays out (i.e., pulls out) the wire, the actual pulling force applied by the first wire winding mechanism becomes larger than the target pulling force by an amount equivalent to the loss caused by this mechanical friction. Because of the above-described separation (i.e., difference) between the actual pulling force of the first wire winding mechanism and the target pulling force thereof in the leg-idling period and the leg-standing period, there is a possibility that the pulling force might not smoothly changed at or near the timing at which the leg-idling period and the leg-standing period are switched from one to the other.

To cope with this problem, in the walking training apparatus 1 according to the first embodiment, the control device 35 performs control, in the leg-idling period, so as to make the motor of the first wire winding mechanism 33 generate a driving force obtained by adding a second driving force for reducing the loss of the pulling force of the first wire winding mechanism 33 caused by the mechanical friction in the first wire winding mechanism 33 to a first driving force. In this way, it is possible to bring the pulling force of the first wire winding mechanism 33 close to the target pulling force thereof in the leg-idling period. Therefore, the separation between the actual pulling force of the first wire winding mechanism 33 and the target pulling force thereof in the leg-idling period can be reduced, thus enabling the pulling force to be changed smoothly at and near the timing at which the leg-idling period and the leg-standing period are switched from one to the other.

Alternatively, the control device 35 performs control, in the leg-standing period, so as to make the motor of the first wire winding mechanism 33 generate a driving force obtained by subtracting the second driving force for reducing the loss of the pulling force of the first wire winding mechanism 33 caused by the mechanical friction in the first wire winding mechanism 33 from the first driving force. In this way, it is possible to bring the pulling force of the first wire winding mechanism 33 close to the target pulling force thereof in the leg-standing period. Therefore, the separation between the actual pulling force of the first wire winding mechanism 33 and the target pulling force thereof in the leg-standing period can be reduced, thus enabling the pulling force to be changed smoothly at and near the timing at which the leg-idling period and the leg-standing period are switched from one to the other.

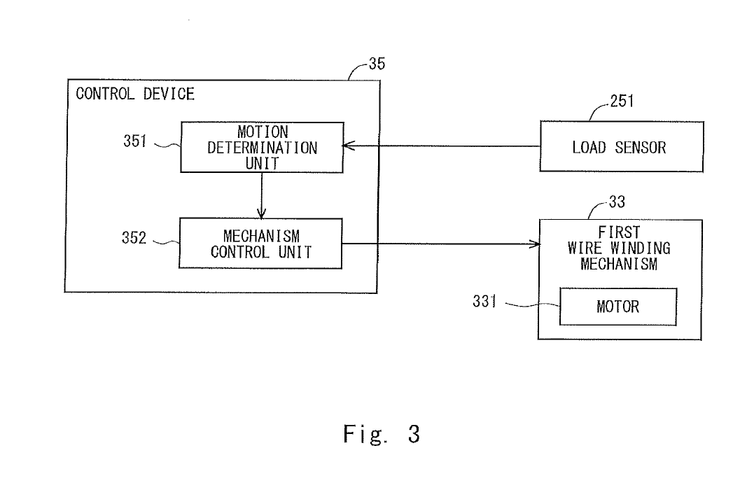

FIG. 3 is a block diagram showing an example of a schematic system configuration of the control device according to the first embodiment. The control device 35 according to the first embodiment incudes a motion determination unit 351 that determines a leg-idling period and a leg-standing period, and a mechanism control unit 352 that controls the motor 331 of the first wire winding mechanism 33 based on a result of the determination by the motion determination unit 351.

The motion determination unit 351 determines, for example, whether trainee's leg is in a leg-standing state or a leg-idling state based on a load value of trainee's sole that is output from a load sensor 251 disposed in the sole frame 25 of the walking assistance apparatus 2. Note that when a plurality of load sensors 251 are arranged in the sole frame 25, for example, an average of load values output from these sensors 251 may be used as the aforementioned load value.

More specifically, when the load value output from the load sensor 251 is equal to or larger than a load threshold, the motion determination unit 351 determines that the leg to which the walking assistance apparatus 2 is attached is in the leg-standing period. On the other hand, when the load value output from the load sensor 251 is smaller than the load threshold, the motion determination unit 351 determines that the leg to which the walking assistance apparatus is attached is in the leg-idling period. In this way, it is possible to easily determine whether the leg is in the leg-standing period or the leg-idling period by using the load sensor 251 disposed in the walking assistance apparatus.

Note that the aforementioned load threshold is obtained by, for example, measuring load values in the state where the leg is in the leg-standing period and those in the state where the leg is in the leg-idling period in advance by using the load sensor 251, and then the obtained load threshold is set (i.e., stored) in the aforementioned memory or the like.

The motion determination unit 351 may calculate the center of gravity of the trainee based on a load value(s) output from the load sensor 251 and determine whether the leg is in the leg-standing period or the leg-idling period based on the calculated center of gravity. For example, areas for the center of gravity in the state where the leg is in the leg-standing period and in the state where the leg is in the leg-idling period are obtained in advance. Then, the motion determination unit 351 determines whether the leg is in the leg-standing period or the leg-idling period by determining in which of the above-described obtained areas the center of gravity of the trainee, which is calculated based on the load value output from the load sensor 251, is included.

The motion determination unit 351 may determine whether the leg to which the walking assistance apparatus is attached is in the leg-standing period or the leg-idling period based on a temporal change (i.e., a change over time) in the angle of the knee joint part of the walking assistance apparatus detected by an angular sensor disposed in the knee joint part. More specifically, the motion determination unit 351 determines that the leg is in the leg-standing period or the leg-idling period when the motion determination unit 351 determines that the detected angle of the knee joint part enters a change area corresponding to the leg-standing period or the leg-idling period based on the temporal change in the angle of the knee joint part detected by the angular sensor.

The motion determination unit 351 may determine whether the leg to which the walking assistance apparatus 2 is attached is in the leg-standing period or the leg-idling period based on user's walking cycle calculated from the moving speed of the belt of the treadmill. The relation between the walking cycle and the moving speed of the belt of the treadmill can be experimentally obtained in advance (e.g., the walking cycle is expressed by a monotone decreasing function including the moving speed of the belt of the treadmill as a variable).

The motion determination unit 351 may determine whether the leg is in the leg-standing period or the leg-idling period based on the amount of the wire 36 stored in the first wire winding mechanism 33 (hereinafter also referred to a “storage amount of wire”). For example, specific storage amounts of the wire 36 in the first wire winding mechanism 33 (such as amounts of winding of the rotor in the first wire winding mechanism 33) in the state where the leg is in the leg-standing period and in the state where the leg is in the leg-idling period are obtained in advance. Then, the motion determination unit 351 may determine whether the leg is in the leg-standing period or the leg-idling period by comparing the obtained specific storage amount with the actual storage amount of the wire 36 in the first wire winding mechanism 33 detected by a sensor or the like.

Note that the above-described methods for determining the leg-standing period and the leg-idling period are merely examples. That is, the determination method is not limited to the above-described methods and other arbitrary determination methods can be used. The motion determination unit 351 outputs a result of the above-described determination of the leg-standing period and the leg-idling period to the mechanism control unit 352. Basically, the mechanism control unit 352 controls the driving force of the motor 331 of the first wire winding mechanism 33 by using a first driving force that is determined in advance so as to reduce the gravitational force of the walking assistance apparatus 2 as a base driving force. For example, the mechanism control unit 352 controls the motor 331 of the first wire winding mechanism 33 so that the vertically-upward component of the pulling force applied by the first wire winding mechanism 33 becomes equal to the gravitational force of the walking assistance apparatus 2. As a result, the load on the walking of the trainee exerted by the gravitational force of the walking assistance apparatus 2 can be reduced.

Further, in response to a determination result that the leg is in the leg-idling period output from the motion determination unit 351, the mechanism control unit 352 performs control so as to make the motor 331 of the first wire winding mechanism 33 generate a driving force obtained by adding a second driving force for reducing a loss of the pulling force of the first wire winding mechanism 33 caused by mechanical friction in the first wire winding mechanism 33 to the first driving force.

Note that the mechanical friction in the first wire winding mechanism 33 means, for example, dynamical friction and/or viscous friction of the rotor winding/rewinding mechanism, the motor 331, and/or the like of the first wire winding mechanism 33.

For example, the mechanism control unit 352 calculates a mechanical friction force F_{T} based on the below-shown expression. Then, the mechanism control unit 352 calculates a second friction force f₂ corresponding to the calculated mechanical friction force F_{T} by multiplying the mechanical friction force F_{T} by a predetermined coefficient. Note that examples of the second friction force f₂ corresponding to the mechanical friction force F_{T} may include not only a second friction force f₂ equal to the mechanical friction force F_{T}, but also a second friction force f₂ for reducing a loss of the pulling force of the first wire winding mechanism 33 that is smaller or larger than the second friction force f₂ equal to the mechanical friction force F_{T}.

F_{T}=T_{dynamic}+K_{f}θ_{V}

In the above-shown expression, T_{dynamic} is a dynamical friction force and K_{f}θ_{V} is a viscous friction force. Further, K_{f} is a viscous friction coefficient and θ_{V} is a rotation speed of the motor 331 or the rotor.

In response to a determination result that the leg is in the leg-idling period by the motion determination unit 351, the mechanism control unit 352 performs control so as to make the motor 331 of the first wire winding mechanism 33 generate a driving force f (f=f₁+f₂) obtained by adding the above-described calculated second driving force f₂ to the first driving force f₁.

In response to a determination result that the leg is in the leg-standing period output from the motion determination unit 351, the mechanism control unit 352 performs control so as to make the motor 331 of the first wire winding mechanism 33 generate a driving force obtained by subtracting a second driving force for reducing a loss of the pulling force of the first wire winding mechanism 33 caused by mechanical friction in the first wire winding mechanism 33 from the first driving force. The second driving force in the leg-standing period can be calculated in a manner similar to that for the above-described calculation for the second driving force in the leg-idling period.

Note that the control device 35 may perform control so as to make the motor 331 of the first wire winding mechanism 33 generate a driving force obtained by adding the second driving force to the first driving force in the leg-idling period, and perform control so as to make the motor 331 of the first wire winding mechanism 33 generate a driving force obtained by subtracting the second driving force from the first driving force in the leg-standing period. In this way, it is possible to bring the pulling force of the first wire winding mechanism 33 close to the target pulling force thereof in the leg-idling period and the leg-standing period. As a result, it is possible to change the pulling force more smoothly at and near the timing at which the leg-idling period and the leg-standing period are switched from one to the other.

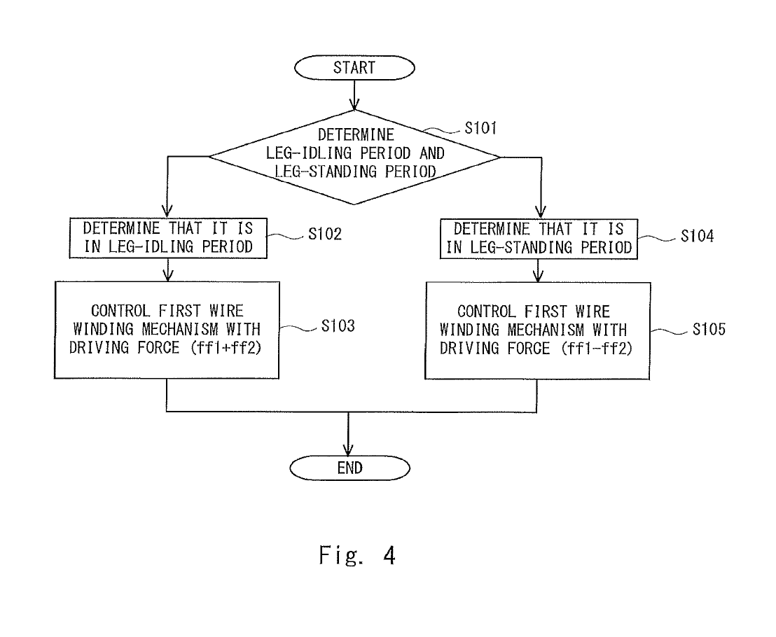

FIG. 4 is a flowchart showing a flow of a method for controlling the walking training apparatus according to the first embodiment. The motion determination unit 351 determines in which of the leg-idling period and the leg-standing period the leg to which the walking assistance apparatus is attached is (step S101).

When the motion determination unit 351 determines that the leg to which the walking assistance apparatus is attached is in the leg-idling period (step S102), in response to this determination result that the leg is in the leg-idling period, the mechanism control unit 352 performs control so as to make the motor 331 of the first wire winding mechanism 33 generate a driving force ff (ff=ff1+ff2) obtained by adding a second driving force ff2 for reducing a loss of the pulling force of the first wire winding mechanism 33 caused by mechanical friction in the first wire winding mechanism 33 to a first driving force ff1 (step S103).

On the other hand, when the motion determination unit 351 determines that the leg to which the walking assistance apparatus is attached is in the leg-standing period (step S104), in response to this determination result that the leg is in the leg-standing period, the mechanism control unit 352 performs control so as to make the motor 331 of the first wire winding mechanism 33 generate a driving force ff (ff=ff1−ff2) obtained by subtracting the second driving force ff2 from the first driving force ff1 (step S105).

As explained above, in the first embodiment, the control device 35 performs control, in the leg-idling period, so as to make the motor 331 of the first wire winding mechanism 33 generate a driving force obtained by adding a second driving force for reducing a loss of the pulling force of the first wire winding mechanism 33 caused by the mechanical friction in the first wire winding mechanism 33 to a first driving force. In this way, it is possible to bring the pulling force of the first wire winding mechanism 33 close to the target pulling force thereof in the leg-idling period, thus enabling the pulling force to be changed smoothly at and near the timing at which the leg-idling period and the leg-standing period are switched from one to the other. Further, the control device 35 performs control, in the leg-standing period, so as to make the motor 331 of the first wire winding mechanism 33 generate a driving force obtained by subtracting the second driving force for reducing the loss of the pulling force of the first wire winding mechanism 33 caused by the mechanical friction in the first wire winding mechanism 33 from the first driving force. In this way, it is possible to bring the pulling force of the first wire winding mechanism 33 close to the target pulling force thereof in the leg-standing period, thus enabling the pulling force to be changed smoothly at and near the timing at which the leg-idling period and the leg-standing period are switched from one to the other.

### Second Embodiment

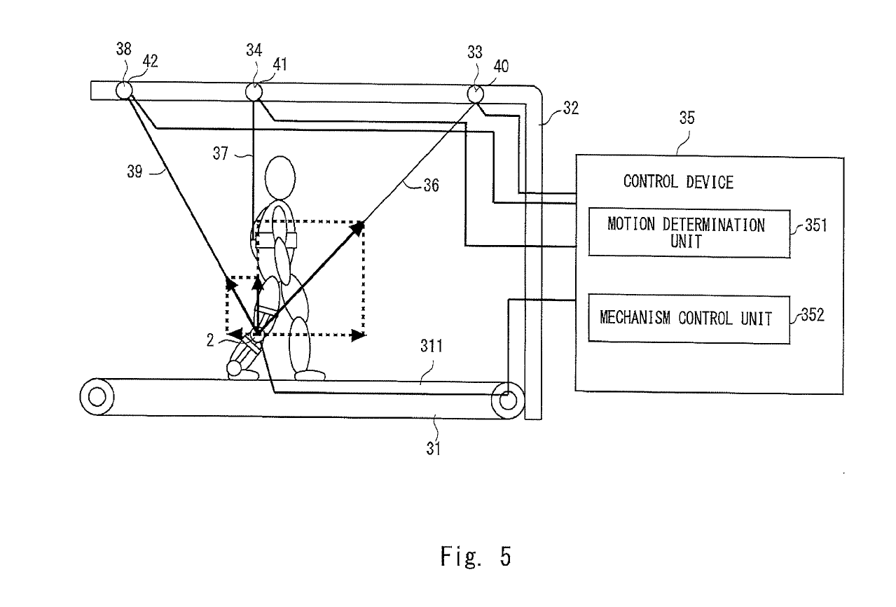

FIG. 5 shows a schematic configuration of a walking training apparatus according to a second embodiment of the present disclosure. The walking training apparatus according to the second embodiment may further include a second wire winding mechanism 38 disposed in the crosswise frame 323 of the frame main body 32. The second wire winding mechanism 38 may pull the walking assistance apparatus 2 upward and backward through a wire 39. The resultant force of the vertically-upward components of the pulling forces applied by the first and second wire winding mechanisms 33 and 38 supports the weight of the walking assistance apparatus 2. Further, the resultant force of the horizontal components of the pulling forces applied by the first and second wire winding mechanisms 33 and 38 assists the start of swinging of the leg.

The mechanism control unit 352 controls the driving force of the motor 331 of the first wire winding mechanism 33 by using a first driving force that is determined in advance so as to reduce the gravitational force of the walking assistance apparatus 2 as a base driving force. At the same time, the mechanism control unit 352 controls the driving force of the motor 331 of the second wire winding mechanism 38 by using a third driving force that is determined in advance so as to reduce the gravitational force of the walking assistance apparatus 2 as a base driving force. Further, the resultant force of the vertically-upward components of the pulling forces applied by the first and second wire winding mechanisms 33 and 38 reduces the gravitational force of the walking assistance apparatus 2. In this way, the vertically-upward components and the horizontally-forward components of the pulling forces applied by the first and second wire winding mechanisms 33 and 38 can be accurately controlled independently of each other. As a result, it is possible to, while reducing the load caused by the gravitational force of the walking assistance apparatus 2, reduce the load exerted on the leg to which the walking assistance apparatus 2 is attached at the start of swinging of the leg more optimally. Note that the other configuration of the second embodiment is roughly identical to that of the above-described first embodiment. Therefore, the same symbols are assigned to the same components and their detailed explanations are omitted.

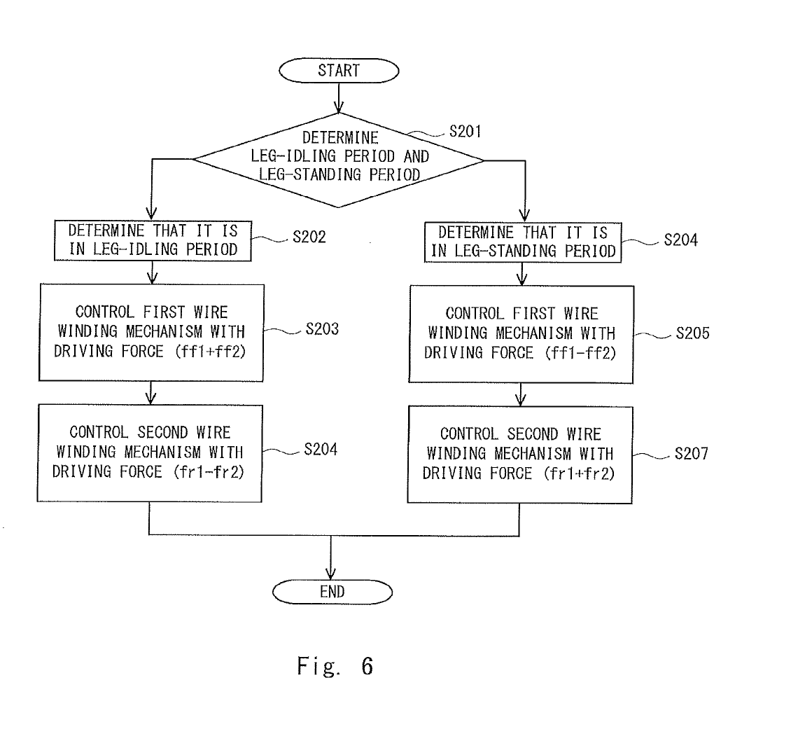

FIG. 6 is a flowchart showing a flow of a method for controlling the walking training apparatus according to the second embodiment.

The motion determination unit 351 determines in which of the leg-idling period and the leg-standing period the leg to which the walking assistance apparatus is attached is (step S201).

When the motion determination unit 351 determines that the leg to which the walking assistance apparatus is attached is in the leg-idling period (step S202), in response to a result of this determination that the leg is in the leg-idling period, the mechanism control unit 352 performs control so as to make the motor 331 of the first wire winding mechanism 33 generate a driving force ff (ff=ff1+ff2) obtained by adding a second driving force ff2 for reducing a loss of the pulling force of the first wire winding mechanism 33 caused by mechanical friction in the first wire winding mechanism 33 to a first driving force ff1 (step S203). At the same time, in response to the result of the determination that the leg is in the leg-idling period, the mechanism control unit 352 performs control so as to make the motor 331 of the second wire winding mechanism 38 generate a driving force fr (fr=fr1−fr2) obtained by subtracting a fourth driving force fr2 for reducing a loss of the pulling force of the second wire winding mechanism 38 caused by mechanical friction in the second wire winding mechanism 38 from a third driving force fr1 (step S204).

On the other hand, when the motion determination unit 351 determines that the leg to which the walking assistance apparatus is attached is in the leg-standing period (step S205), in response to a result of this determination that the leg is in the leg-standing period, the mechanism control unit 352 performs control so as to make the motor 331 of the first wire winding mechanism 33 generate a driving force ff (ff=ff1−ff2) obtained by subtracting the second driving force ff2 from the first driving force ff1 (step S206). At the same time, in response to the result of the determination that the leg is in the leg-standing period, the mechanism control unit 352 performs control so as to make the motor 331 of the second wire winding mechanism 38 generate a driving force fr (fr=fr1+fr2) obtained by adding the fourth driving force fr2 to the third driving force fr1 (step S207).

Note that the present disclosure is not limited to the above-described embodiments, and various modifications can be made without departing from the spirit and scope of the present disclosure.

The first and second embodiments can be combined as desirable by one of ordinary skill in the art.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A walking training apparatus comprising:
a walking assistance apparatus configured to be attached to a leg of a trainee and assist a walking motion performed by the trainee;
a first wire winding mechanism configured to pull a wire connected to the leg directly or through the walking assistance apparatus upward and forward by winding the wire connected to the leg; and
a controller configured to control a driving force of a motor of the first wire winding mechanism by using a first driving force as a base driving force, the first driving force being determined in advance so as to reduce a gravitational force of the walking assistance apparatus,
wherein the first wire winding mechanism winds the wire by rotating the motor in a leg-idling period and pays out the wire by rotating the motor in a direction opposite to the direction in the leg-idling period in a leg-standing period, the leg-idling period being a period in which the leg is in an leg-idling state in the walking motion of the trainee, the leg-standing period being a period in which the leg is in a leg-standing state in the walking motion of the trainee, and
wherein the controller performs at least one of:
control, in the leg-idling period, so as to make the motor of the first wire winding mechanism generate a driving force obtained by adding a second driving force to the first driving force, the second driving force being a force for reducing a loss of the pulling force of the first wire winding mechanism caused by mechanical friction in the first wire winding mechanism; and
control, in the leg-standing period, so as to make the motor of the first wire winding mechanism generate a driving force obtained by subtracting the second driving force from the first driving force, the second driving force being the force for reducing the loss of the pulling force of the first wire winding mechanism caused by the mechanical friction in the first wire winding mechanism.

2. The walking training apparatus according to claim 1, further comprising a second wire winding mechanism configured to pull the wire connected to the leg directly or through the walking assistance apparatus upward and backward by winding the wire connected to the leg,
wherein the second wire winding mechanism winds the wire by rotating the motor in the leg-idling period and pays out the wire by rotating the motor in the direction opposite to the direction in the leg-idling period in the leg-standing period, the leg-idling period being the period in which the leg is in the leg-idling state in the walking motion of the trainee, the leg-standing period being the period in which the leg is in the leg-standing state in the walking motion of the trainee, and
the controller controls a driving force of a motor of the second wire winding mechanism by using a third driving force as a base driving force, the third driving force being determined in advance so as to reduce the gravitational force of the walking assistance apparatus, and
wherein the controller performs at least one of:
control, in the leg-idling period, so as to make the motor of the second wire winding mechanism generate a driving force obtained by subtracting a fourth driving force from the third driving force, the fourth driving force being a force for reducing a loss of the pulling force of the second wire winding mechanism caused by mechanical friction in the second wire winding mechanism; and
control, in the leg-standing period, so as to make the motor of the second wire winding mechanism generate a driving force obtained by adding the fourth driving force to the third driving force, the fourth driving force being the force for reducing the loss of the pulling force of the second wire winding mechanism caused by the mechanical friction in the second wire winding mechanism.

3. A control method for a walking training apparatus, the walking training apparatus comprising:
a walking assistance apparatus configured to be attached to a leg of a trainee and assist a walking motion performed by the trainee;
a first wire winding mechanism configured to pull a wire connected to the leg directly or through the walking assistance apparatus upward and forward by winding the wire connected to the leg; and
a controller for controlling a driving force of a motor of the first wire winding mechanism by using a first driving force as a base driving force, the first driving force being determined in advance so as to reduce a gravitational force of the walking assistance apparatus,
wherein the first wire winding mechanism winds the wire by rotating the motor in a leg-idling period and pays out the wire by rotating the motor in a direction opposite to the direction in the leg-idling period in a leg-standing period, the leg-idling period being a period in which the leg is in an leg-idling state in the walking motion of the trainee, the leg-standing period being a period in which the leg is in a leg-standing state in the walking motion of the trainee, and
wherein the control method comprises at least one of:
performing control, in the leg-idling period, so as to make the motor of the first wire winding mechanism generate a driving force obtained by adding a second driving force to the first driving force, the second driving force being a force for reducing a loss of the pulling force of the first wire winding mechanism caused by mechanical friction in the first wire winding mechanism; and
performing control, in the leg-standing period, so as to make the motor of the first wire winding mechanism generate a driving force obtained by subtracting the second driving force from the first driving force, the second driving force being the force for reducing the loss of the pulling force of the first wire winding mechanism caused by the mechanical friction in the first wire winding mechanism.
